(19) United States
(12) Patent Application Publication
(10) Pub. No.: US 2005/0024882 A1
(43) Pub. Date: Feb. 3, 2005

(54) Electrical switch utilizing ball for lamps and like appliances

(76) Inventor: Roger Sherman, Chelsea, MA (US)

Correspondence Address: Todd S. Parkhurst, 30th Floor, 131 South Dearborn St., Chicago, IL, 60603, US

(21) Appl. No.: 10/924,170

(22) Filed: Aug. 23, 2004

Related U.S. Application Data
(63) Continuation-in-part of application No. 10/356,284, filed on Jan. 31, 2003.
(60) Provisional application No. 60/510,353, filed on Oct. 10, 2003.

(51) Int. Cl. F21L 4/04

(52) U.S. Cl. 362/419

(57) ABSTRACT

A lamp having as novel on-off switch is disclosed and claimed. The lamp includes a low voltage lamp switch having a first pole permanently connected to a remote source of electric power; a second pole permanently connected to a light; and a movable switch element permanently connected to the first pole and selectively movable into and out of electrical connection with the second pole. In the illustrated embodiment of the invention, the movable switch element includes a flexible cable having a first end connected to the first pole, and an electrically conductive ball mounted to the cable free end. The second pole here comprises a cup adapted to receive a ball, and the second pole cup is electrically connected to a light.

### RELATED APPLICATIONS

This application claims domestic priority from U.S. Provisional Application 60/510,353, filed Oct. 10, 2003.

This application is a continuation-in-part of U.S. Utility application Ser. No. 10/356,284, filed Jan. 31, 2003.

### BACKGROUND OF THE INVENTION

Electric lamps for desks and like home and office environments are ubiquitous. Lamps having high-intensity lights have become important in the marketplace. Especially attractive in the current marketplace are those lamps which embody modern, eye-catching designs, appearances and features.

It is an object of this invention to provide a desk lamp or like electrical appliances which has an attractive and unusual-appearing on-off lamp switch.

A related object is to provide a desktop lamp with an attractive on-off switch which operates, in one embodiment, at a harmlessly low voltage.

Another object is to provide an attractive desk lamp and associated on-off switch which are safe, reliable, rugged in operation, and yet economical to manufacture.

Still another object is to provide an on-off switch for a lamp, the operation of which is self-evident yet interesting and attractive to the owner or user.

Other objects and advantages of the invention will become apparent upon reading the following detailed description and upon reference to the drawings. Throughout the drawings, like reference numerals refer to like parts.

### DESCRIPTION OF THE DRAWINGS

FIG. 1 is an isometric view of a lamp having an on-off switch embodying the present invention.

FIG. 2 is a right side elevational view of the lamp shown in FIG. 1.

FIG. 3 is a left-side elevational view of the lamp shown in FIG. 2.

FIG. 4 is an isometric view similar to FIG. 1, but showing a lamp having an alternate embodiment of the on-off switch.

FIG. 5 is a partial fragmentary sectional view taken substantially in the plane of line 5-5 in FIG. 4 and showing the alternate on-off switch.

FIG. 6 is a partial fragmentary sectional view taken substantially in the plane of line 5-5 in FIG. 4 and showing yet another alternate embodiment of the on-off switch.

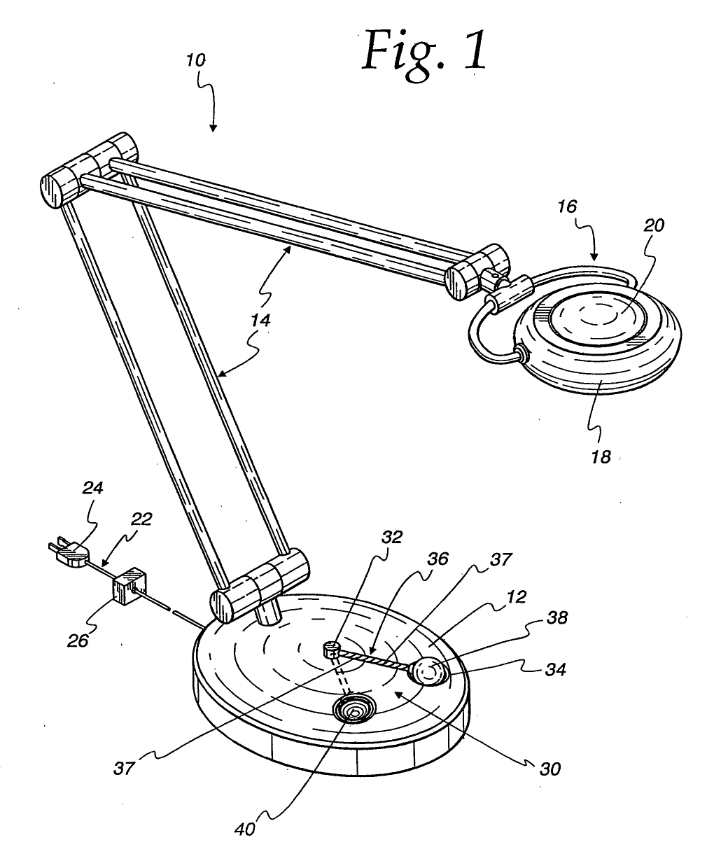

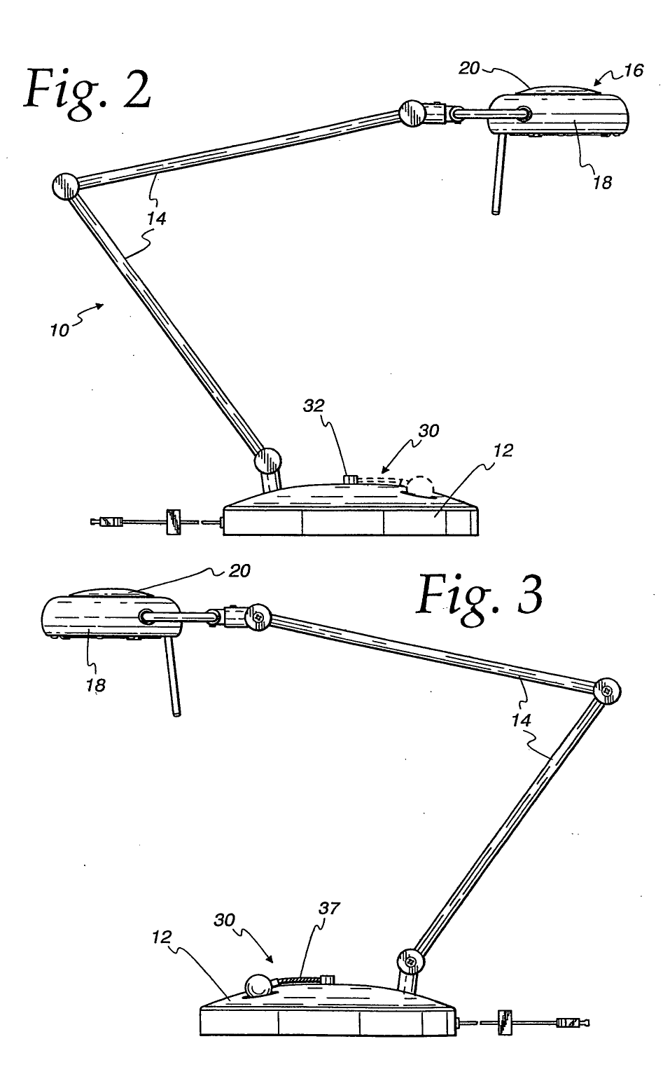

### DETAILED DESCRIPTION

Turning more specifically to the drawings, a lamp 10 embodying the present invention includes a base 12 here taking the form of an articulating arm or standard 14 which mounts, in turn, a head or illuminating unit 16. This illuminating head 16 includes a light mount 18 enclosing a light 20. In this first embodiment of the invention, this light 20 is of the high-intensity, low-voltage type, such as that manufactured by, for example, the Jiangson Wujin Fuxing Electrical Appliance Company, Ltd. of Chang Zhou, Jiangsu, China. A power cord 22 extends from a remote source of electric power of standard variety to the lamp base 12. The power cord 22 includes a plug 24. A transformer 26 converts the standard domestic power (for example, 120 volts, 60 Hz AC) to a 12 volt alternating current which the light 20 is designed to utilize. The transformer can be obtained from the Yang Guang Electronic Company of Bei—an Industry District, Huang Jiang Dong Guan, Guang Dong, China.

Wiring (not completely shown) provides a normal electrically conductive path extending from the remote power source through the power cord 22 and transformer 26 to a novel low voltage on —off switch 30, and from the novel switch 30 up through the arm 14 to the light 20.

The illustrated lamp base 12 mounts and supports both the arm 14 and a novel switch 30. In accordance with one object of the invention, this novel switch 30 is attractive yet its operation is self-evident to any user. Although electric current passes directly through the switch 30, that current is of low voltage and is consequently harmless. In accordance with this aspect of the invention, the switch 30 includes a first pole 32 permanently connected, through the electrically conductive path 22, to the transformer 26 and the remote power source (not shown) via the plug 24. A second pole 34 is permanently connected, via the electrically conductive path, to the light 20. A movable switch element 36 here includes a flexible, electrically conductive cable 37 which is fixed at one end to the first pole, and an electrically conductive ball 38 is mounted at the cable free end. The flexible cable 36 is electrically connected at a fixed end to the first pole 32, and at its free end to the ball 38. A third pole 48 is also located on the base 12, and it is spaced apart from the second pole 34.

The second pole 34 takes the form of a small cup adapted to receive and retain the ball 38, and is formed of a suitable metal or other electrically conductive material. Similarly, the third pole 48 takes the form of a small cup adapted to receive and retain that ball 38, but it is formed a plastic or other electrically insulating material. When the lamp is connected to the remote power source and the ball 38 rests in the conductive second pole cup 34, the lamp is on; and when the ball 38 rests in the insulated third pole cup 40, the lamp is off. It will be self-evident to any lamp user that the lamp may be turned on or off by moving the ball 38 between the cups 34 and 48.

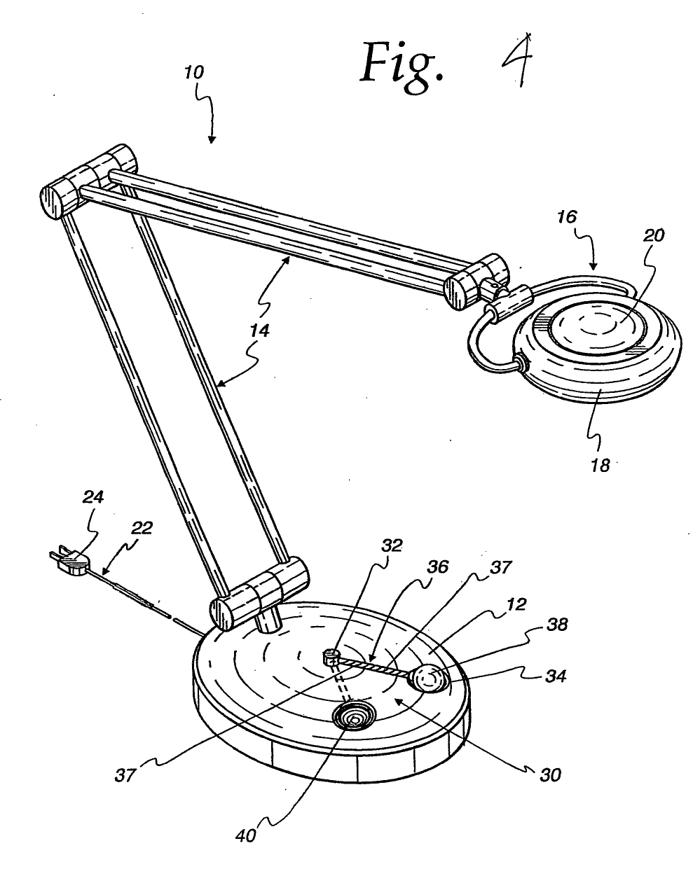

A lamp 10 having alternate embodiments of the lamp switch are shown in FIGS. 4, 5 and 6. Here, the lamp power cord 22 is embodied as a normal household power cord conducting, for example, 110 V 60 Hz alternating current from a remote power source (not shown) to the lamp 10.

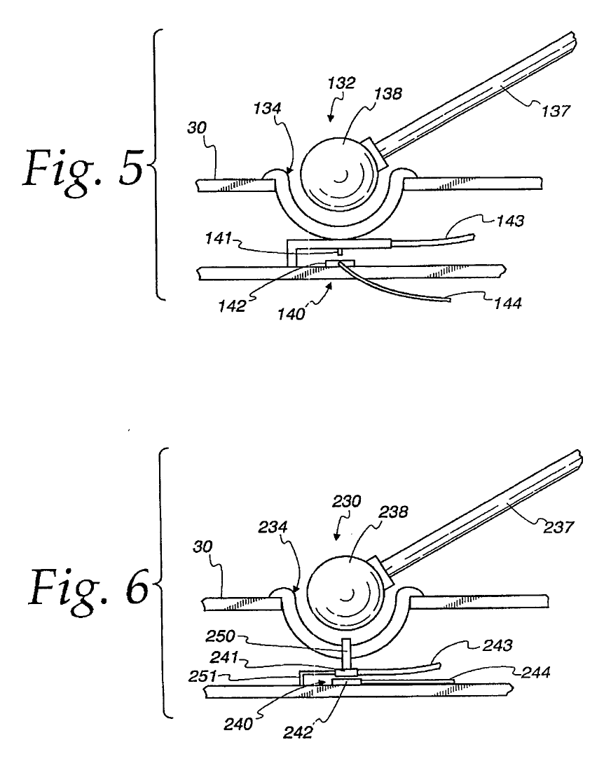

A second embodiment of the ball switch is shown in FIG. 5. Here, this switch 130 safely accommodates normal household power but does not expose the lamp user to contact with any electric current. To accomplish this, the switch includes a ball 138 which can be made of any electrically conductive or even non-conductive material. The ball 138 can be tethered to the lamp by a suitable conductive or non-conductive cord 137. The ball 138 is adapted to fit within an insulating cup 134, and is, in this embodiment, made of a suitable flexible material such as a plastic polymer.

Here the second pole includes, below the cup 134, a switch 140 having contacts 141, 142. Each of these contacts 141, 142 is connected in any suitable manner to conductive wiring 143, 144. When the ball 138 is placed within the cup 134, the weight of the ball 138 presses the contacts 141, 142 into electrically conductive engagement, turning on the lamp 10. When the ball 138 is removed, the resilience of the cup 134 and the contact 141 move the contacts 141, 142 out of engagement with each other, thereby turning off the lamp.

Another embodiment of the switch is shown in FIG. 6. Here, the switch 230 includes a ball 238 and tethered cord 237 like those of the switch shown in FIG. 5. The second pole here includes a non-conductive cup 234 is adapted to retain the ball 238, and below the cup 234, an electrical switch 242 having opposing contacts 241 and 242. Wires 243 and 244 lead from the contacts 241, 242 to the lamp bulb.

Extending from one contact 241 and through the cup 234 is a pin 250. When the ball 238 engages the pin 250, the pin 250 and mounted contact 241 are pressed downwardly so that the contact 241 engages the confronting contact 242, thus turning on the lamp bulb. A resilient member 251 can mount the pin 250 or upper contact 241 so as to bias the upper contact 241 into an open, normally lamp off configuration.

Other arrangements and embodiments of the switches 30, 130, and 230 can be provided without departing from the spirit and scope of the invention as defined in the appended claims.

1. A lamp, comprising, in combination,
a light,
a lamp switch, and
an electrically conductive path extending from a standard power source through the switch to the light,
the switch including
a first pole adapted to be permanently connected, through the electrically conductive path, to the power source,
a second pole permanently connected, through the electrically conductive path, to the light,
and a movable switch element permanently connected to one of the poles and selectively movable into and out of content with the other pole so as to provide a correspondingly selective electrical connection between the power source and said light.

2. A lamp according to claim 1 wherein said movable switch element includes a fixed end permanently connected to the first pole and a free end selectively movable into and out of electrical connection with the second pole.

3. A lamp according to claim 2 wherein said switch element includes a flexible cable electrically connecting the switch element fixed end and free end.

4. A lamp according to claim 1 wherein said switch element includes a third pole electrically insulated from said light, and positioned to selectively and mechanically engage the switch element free end, whereby, when the switch element free end is retained by the insulated third pole, the light is off.

5. A lamp according to claim 2 wherein said switch element second pole is electrically connected to the light, whereby, when the switch element free end contacts the second pole, the light can be on.

6. A lamp according to claim 2 wherein said switch element free end is a ball.

7. A lamp according to claim 6 wherein said second pole is a cup adapted to receive the switch element free end ball.

8. A lamp according to claim 4 wherein said switch element insulated third pole is a cup adapted to receive a ball.

9. A lamp according to claim 1 further including a base supporting said light.

10. A lamp according to claim 1 further including a base mounting said switch.

11. A lamp according to claim 10 wherein said switch includes a first pole mounted to said base.

12. A lamp according to claim 10 wherein said switch second pole is mounted to said base, and wherein said second pole comprises a cup adapted to receive a switch element free end ball and wherein said second pole is electrically connected, through the electrically conductive path, to the light.

13. A lamp according to claim 10 wherein said switch includes a third pole mounted to the base, and wherein said third pole comprises a cup mounted to the base but electrically insulated from said electrically conductive path.

14. A lamp base mounting a low-voltage switch for a low-voltage lamp, the switch including
a first pole permanently connected to a source of electric power,
a second pole permanently connected to a light,
and a movable switch element permanently connected to one pole and selectively movable into and out of electrical connection with the other pole.

15. A lamp base according to claim 14 wherein said movable switch element includes a fixed end permanently connected to one pole and a free end selectively movable into and out of electrical connection with the other pole.

16. A lamp base according to claim 14 wherein said switch element includes a flexible cable permanently connected to one pole and having a free end.

17. A lamp base according to claim 16 wherein said switch element includes a third pole electrically insulated from said light, and positioned to selectively and mechanically engage the switch element free end, whereby, when the switch element free end is retained by the insulated third pole, the light is off.

18. A lamp base according to claim 16 wherein the switch element free end is a ball.

19. A lamp base according to claim 18 wherein said other pole is a cup adapted to receive the switch element free end ball.

20. A lamp base according to claim 17 wherein said switch element insulated third pole is an electrically insulated cup adapted to receive the switch element free end ball.
